(19) United States
(12) Patent Application Publication
(10) Pub. No.: US 2014/0025946 A1
(43) Pub. Date: Jan. 23, 2014

(54) AUDIO-SECURITY STORAGE APPARATUS AND METHOD FOR MANAGING CERTIFICATE USING THE SAME

(71) Applicant: Electronics and Telecommunications Research Institute, (US)

(72) Inventors: Seok Hyun Kim, Daejeon (KR); Jong-Hyouk Noh, Daejeon (KR); Seung-Hyun Kim, Daejeon (KR); Jin-Man Cho, Daejeon (KR); Young Seob Cho, Daejeon (KR); Sangrae Cho, Daejeon (KR); Dae Seon Choi, Daejeon (KR); Soo Hyung Kim, Daejeon (KR); Seung Hun Jin, Daejeon (KR)

(73) Assignee: Electronics and Telecommunications Research Institute, Daejeon (KR)

(21) Appl. No.: 13/728,199

(22) Filed: Dec. 27, 2012

(30) Foreign Application Priority Data
Jul. 17, 2012 (KR) 10-2012-0077663

(51) Int. Cl. H04L 29/06

(52) U.S. Cl. CPC H04L 63/0823
USPC 713/156

(57) ABSTRACT

An audio-security storage apparatus includes an audio connector for connecting with to an audio jack equipped in an external apparatus, and a audio-security storage module for transmitting information on certificates to the external apparatus or receiving information on certificates from the external apparatus for the storage thereof.

### RELATED APPLICATION(S)

This application claims the benefit of Korean Patent Application No. 10-2012-0077663, filed on Jul. 17, 2012, which is hereby incorporated by reference as if fully set forth herein.

### FIELD OF THE INVENTION

The present invention relates to management of a certificate, and more particularly, to an audio-security storage apparatus having an audio connection through which a certificate is received from an external apparatus and the certificate is transferred to the external apparatus, and a method for managing the certificate using the same.

### BACKGROUND OF THE INVENTION

A certificate is commonly used for an authentication in a personal computer. In recent, as smart phones able to perform wireless communication and use an application program such as mobile banking transactions or the like while being always carried around have become prevalent, 98% of the economically active population of Korea uses certificates by using smart phones as well as personal computers.

However, like personal computers, smart phones are also able to freely download application programs desired by users and install the same, but have a high possibility of being hacked by malicious codes.

For this reason, most users who use banking transactions through personal computers store a certificate in a stable external repository such as an external storage medium, e.g., a USB, a security token or the like. Meanwhile, users who use banking transactions through mobile terminals, e.g., smart phones store a certificate in an internal storage space and use the certificate because they cannot use an interface such as USB. Therefore, an issue of a leakage of a certificate through hacking has been steadily raised in relation to banking transactions using mobile terminals. In addition, a procedure of duplicating a certificate in a mobile terminal is complicated and a certificate stored in an external apparatus needed to be updated whenever the certificate is updated, causing inconvenience, and thus, demand for a solution thereto has also been increased.

To solve such problems, recently, a method of storing a certificate in a USIM (Universal Subscriber Identity Module) has been proposed and a technique for storing a certificate using RF communication has been suggested. However, these methods are not proper to commonly share a single certificate in every external apparatus, and therefore the problem that each device should duplicate a certificate remains unsolved.

Therefore, there is a need to utilize a certificate without duplicating it in every external apparatus.

### SUMMARY OF THE INVENTION

In view of the above, therefore, the present invention provides an audio-security storage apparatus having audio connections through which a certificate is received from an external apparatus and the certificate is transferred to the external apparatus, and a method for managing a certificate using the same.

In accordance with the present invention, there is provided an audio-security storage apparatus, which includes: an audio connector adapted to connect to an audio jack equipped in an external apparatus; and a security storage module configured to transmit information on certificates to the external apparatus or receive information on certificates from the external apparatus for the storage thereof.

The audio-security storage apparatus may further include a gender configured to perform an interface between the external apparatus and the security storage apparatus.

Preferably, the security storage module includes: an input/output interface configured to receive or transmit signals through the audio connector; a signal conversion unit configured to convert analog signals received from the external apparatus through the input/output interface into digital signals or convert digital signals generated in the audio-security storage apparatus into analog signals; a certificate management unit storing a list of functions corresponding to the digital signals and the information of the certificates; a signal identification unit configured to identify only digital signals associated with certification, among the digital signals converted through the signal conversion unit, based on the list; and a control unit configured to perform a function corresponding to the identified digital signal.

Preferably, the control unit is configured to perform a function of generating a response signal depending on a request from the external apparatus, a function of generating a symmetric key for encryption of the information on the certificates, a password verification function of verifying a password stored in the certificate management unit and a password received from the external apparatus, and a function of checking integrity of data transmitted between the external apparatus and the security storage device.

Preferably, the security storage module further includes: an encryption/decryption unit configured to encrypt or decrypt signals communicated between the external apparatus and the security storage device.

Preferably, the security storage module further includes: a power supply unit configured to supply a power to the audio-security storage apparatus using the signal received through the input/output interface.

Preferably, the control unit is configured to store a certificate and a digital signature key thereof in the certificate management unit, or store entity information of a certificate and a digital signature key thereof in the certificate management unit.

Preferably, the security storage module further includes: a lamp driving unit configured to flicker a lamp depending on whether or not the power is supplied to the audio-security storage apparatus and provide a function of turning on or off the power to the security storage apparatus.

Preferably, the audio connector includes a 4-pole audio connector, the 4-pole audio plug having a stereo 2-pole for an input channel, a ground 1-pole for a terminal to supply the power, and a microphone 1-pole for an output channel.

In accordance with the present invention, there is provided a method for managing certificates, which includes: detecting a connection of an audio-security storage apparatus to an audio jack of an external apparatus; receiving an identification message from the external apparatus; checking whether or not a password has been registered when the identification message is included in a predetermined function list; transmitting an acknowledgement signal for the identification message and a password request signal to the external apparatus; receiving a response for the password request signal from the external apparatus; comparing the response and the password to verify the password; generating a symmetric key for data communication with the external apparatus when the verification is completed; and displaying a connection result when the connection of the external apparatus and the security storage device is completed.

Preferably, the method further includes: providing a message to register the password to the external apparatus when the password has not been registered; receiving the password from the external apparatus; and transmitting a response signal to the receipt of the password to the external apparatus.

Preferably, the method further includes: receiving a cipher text which is obtained by encrypting a certificate and a digital signature key using the symmetrical key and a hash value for the certificate and the digital signature key from the external apparatus for the storage of the same in a certificate management unit.

Preferably, the method further includes: receiving a cipher text which is obtained by encrypting entity information of a certificate and a digital signature key thereof using the symmetrical key and a hash value for the entity information of the certificate and the digital signature key from the external apparatus for the storage of the same in a certificate management unit.

Preferably, the cipher text and the hash value are checked to perform verification thereof before being stored in the certificate management unit.

Preferably, the method further includes: receiving signals requesting entity information of certificates from the external apparatus; extracting entity information of certificates stored in the certificate management unit according to the received signals; selecting any one of the entity information of the certificates; searching the certificate management unit for a certificate corresponding to the selected entity information; and encrypting the searched certificate and a digital signature key of the searched certificate to transmit the same to the external apparatus.

Preferably, the method further includes: receiving entity information of certificates stored in a storage device from the external apparatus; extracting the entity information of certificates by comparing the received entity information and entity information stored in the certificate management unit; transmitting the extracted certificate information to the external apparatus, wherein the external apparatus extracts a certificate corresponding to the selected entity information from the storage device when selected any one of the transmitted entity information of certificates; searching the certificate management unit for a certificate identical to the selected entity information; and encrypting a digital signature key of the searched certificate to transmit the same to the external apparatus.

### BRIEF DESCRIPTION OF THE DRAWINGS

The above and other objects and features of the present invention will become apparent from the following description of preferred embodiments, given in conjunction with the accompanying drawings, in which:

FIG. 1 schematically illustrates an audio-security storage apparatus in accordance with an embodiment of the present invention;

FIG. 2 is a block diagram of the audio-security storage apparatus illustrated in FIG. 1;

FIGS. 3A and 3B are a control flow diagram illustrating a process of performing a physical connection and verification between an external apparatus and the audio-security storage apparatus in accordance with an embodiment of the present invention;

FIG. 4 is a control flow diagram illustrating a process of storing a certificate in the audio-security storage apparatus in accordance with an embodiment of the present invention; and

FIG. 5 is a control flow diagram illustrating a process of utilizing the certificate stored in the audio-security storage apparatus in accordance with an embodiment of the present invention.

### DETAILED DESCRIPTION OF THE EMBODIMENTS

The advantages and features of embodiments and methods of accomplishing these will be clearly understood from the following embodiments taken in conjunction with the accompanying drawings. Embodiments are not limited and may be implemented in various forms. It should be noted that the embodiments are provided to make a full disclosure and also to allow those skilled in the art to understand the full range of the embodiments. Therefore, embodiments are to be defined only by the scope of the appended claims.

Hereinbefore, while the embodiments of the present disclosure are described, they are exemplary ones only and one of ordinary skill in the art may recognize that various alterations and modifications that fall within the scope of the present disclosure may be possible. Accordingly, the true technical protection scope of the present disclosure should be defined by the following claims.

Hereinafter, embodiments of the present invention will be described in detail with the accompanying drawings.

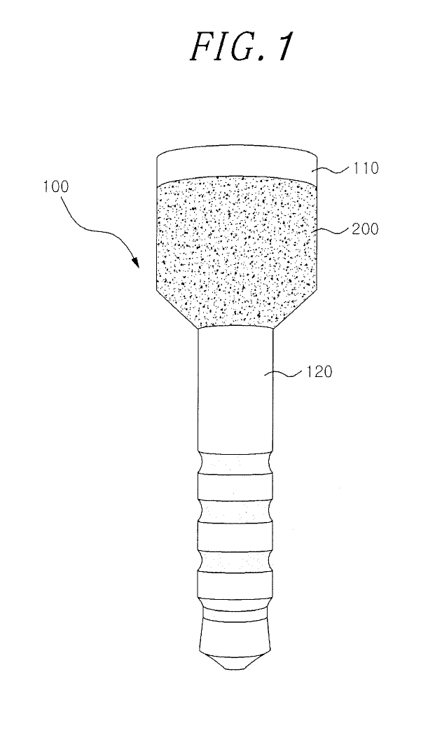

FIG. 1 schematically illustrates an audio-security storage apparatus in accordance with an embodiment of the present invention.

An audio-security storage apparatus 100 functions to receive a certificate from an external apparatus 250 for storing it, or provide the stored certificate to the external apparatus 250. As illustrated in FIG. 1, the audio-security storage apparatus 100 includes an audio connector 120, a lamp 110, and an audio-security storage module 200.

The audio connector 120 may be connected to an audio jack or socket equipped in the external apparatus 250 through which an audio signal is transmitted and received to and from the external apparatus 250. For example, the audio connector 120 may have a type of 4-pole audio connector. Herein, the 4-pole audio connector is composed of a 2-pole for stereo, a 1-pole for ground, and a 1-pole for microphone. In a case where the external apparatus 250 is a smart phone, the audio connector 120 is directly connected to an audio jack equipped in the smart phone. In a case where the external apparatus is a personal computer, a notebook computer, or the like using a 3.5 pi audio jack with separated voice and microphone, the audio connector 120 is connected to the external apparatus 250 through an extender or gender capable of performing an interface between the 3.5 pi audio jack and the audio connector which is the type of 4-pole audio connector.

The lamp 110 may flicker depending on whether or not power is supplied to the audio-security storage apparatus 100. In addition, the audio-security storage apparatus 100 may further include a button (not shown) for selectively supplying power to the audio-security storage module 200 or cutting off the power supply.

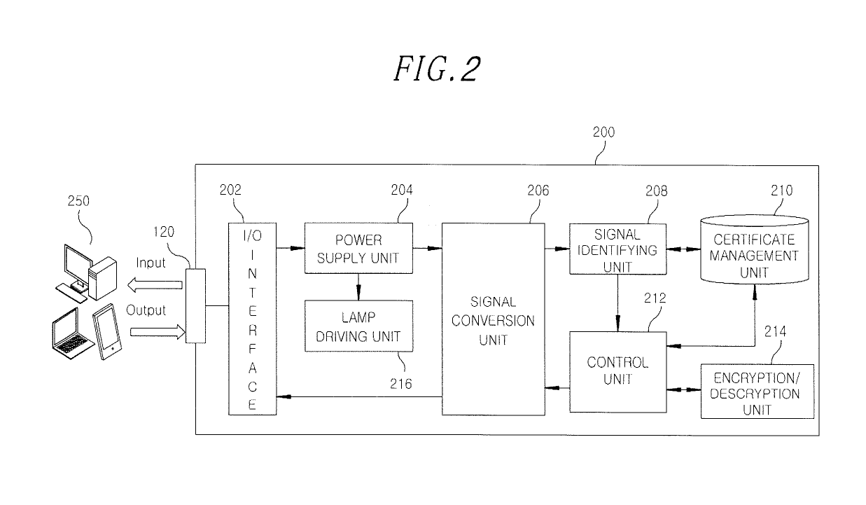

FIG. 2 is a block diagram of the security storage apparatus, in particular, the audio-security storage module 200 in accordance with an embodiment of the present invention.

As illustrated in FIG. 2, the audio-security storage module 200 includes an input/output (I/O) interface 202, a power supply unit 204, a signal conversion unit 206, a signal identification unit 208, a certificate management unit 210, a control unit 212, an encryption/decryption unit 214, and a lamp driving unit 216.

As set forth above, the audio connector 120 may be a type of a 4-pole audio connector and is connected to the I/O interface 202 to transmit and receive an audio signal to and from the external apparatus 250. Specifically, the audio connector 120 has poles for a stereo and a microphone used to transmit and receive audio signals as well as data to and from the external apparatus 250. The 4-pole audio connector may be composed of a stereo 2-pole for input channels, a ground 1-pole for power supply, and a microphone 1-pole for an output channel.

In accordance with the embodiments of the present invention, the audio-security storage apparatus 100 is configured to receive and transmits data from and to the external apparatus 250 through such audio connector 120, and generate a voltage using an audio signal received through the audio connector 120. (See, Ye-Sheng Kuo, Thomas Schmid, Prabal Dutta, “Hijacking Power and Bandwidth from the Mobile Phone's Audio Interface”, ACM DEV '10 Proceedings of the First ACM Symposium on Computing for Development, Article No. 24)

In the embodiment, the external apparatus 250 may refer to any devices having a 3.5 pi 4-pole audio jack. For another example, a personal computer or a notebook computer may equip with a 3.5 pi audio jack with for separate voice and microphone. In such a case, the audio connector 120 may be connected to the external apparatus 250 such as the personal computer or the notebook computer via an extender or a gender capable of performing an interface between the 4-pole audio connector 120 and the 3.5 pi audio jack of the external apparatus 250.

The I/O interface 202 is connected to the audio connector 120 through which audio signals are transmitted to the external apparatus 250 or received from the external apparatus 250.

The power supply unit 204 supplies a constant voltage to the audio-security storage module 200 through the I/O interface 202.

The signal conversion unit 206 converts audio signals received through the I/O interface 202 into digital signals or converts digital signals generated in the audio-security storage module 200 into audio signals (e.g., analog audio signals). The converted audio signals are then provided to the external apparatus 250 through the I/O interface 202.

The signal identification unit 208 recognizes functions corresponding to the digital signals converted by the signal conversion unit 206, extracts only signals related to the audio security storage device 200 and transfers the extracts signals to the control unit 212 based on the recognition result. A function list for signals is predefined and stored in the certificate management unit 210. More specifically, the signal identification unit 208 compares a digital signal with the function list stored in the authenticate management unit 210 and recognizes the digital signal as to which function it is to perform.

The authenticate management unit 210 may includes a memory which stores information regarding certificates and the function list. The certificate information may be stored in the form of Key/Value within the authenticate management unit 210 and by either an integrated storage method or a separated storage method depending on a user selection. For the integrated storage method, the Key may be entire information of the certificate, and the Value may be a digital signature key for the certificate. For the separated storage method, the Key may be entity information of the certificate and the Value may be a digital signature key for the certificate.

The control unit 212 performs a function corresponding to the digital signal recognized by the signal identification unit 208. For example, the control unit 212 may perform a function of, e.g., generating a response signal, generating of a symmetric key, verifying a password, verifying integrity, or the like.

The function of generating a response signal is to perform a function corresponding to the recognized digital signal, generate the result value for the performance, and convert the result value into an analog signal. The converted analog signal will then be provided to the external apparatus 250.

The function of generating a symmetric key is to generate an encryption key to be used during the encryption of signals transmitted and received between the audio-security storage module 200 and the external apparatus 250. The symmetric key is newly generated each time the audio-security storage module 200 is physically connected with the external apparatus 250. The function of verifying a password is to check whether or not a password of the audio-security storage apparatus 100 stored in the certificate management unit 210 is identical to a password received from the external apparatus 250.

The integrity function is to check data integrity transmitted and received between the external apparatus 250 and the audio-security storage module 200 by generating or comparing a hash value for the data. An available hash algorithm may be SHA1 (Secure Hash Algorithm 1), MD5 (Message-Digest algorithm 5), or the like, and as the encryption method, AES (Advanced Encryption Standard), DES (Data Encryption Standard), or the like is used.

The encryption/decryption unit 214 performs to encrypt and decrypt data transmitted between the audio-security storage apparatus 100 and the external apparatus 250 devices by using a symmetric key generated at the time when the external apparatus 250 and the audio security storage device 200 are physically connected each other.

The lamp driving unit 216 makes the lamp 110 flicker by virtue of the power supply unit 204.

The lamp driving unit 216 may be provided with a switch unit used to turn on or turn off an operation of the audio-security storage apparatus 100 by controlling the power supply unit 204.

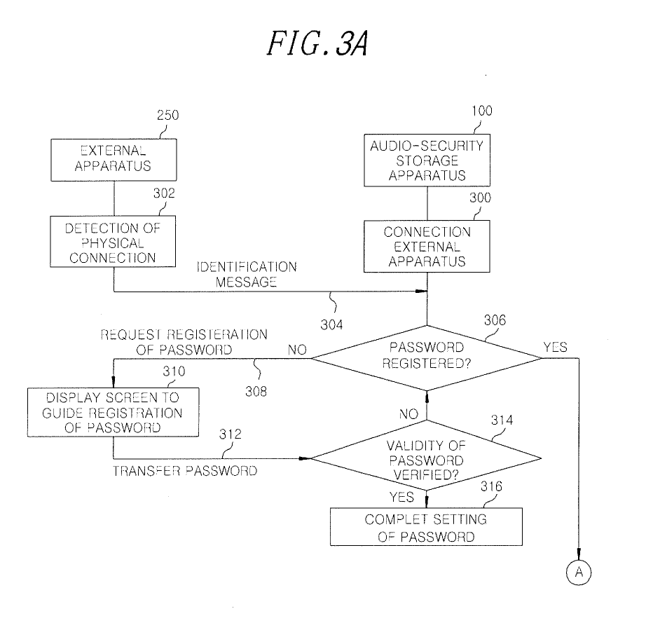

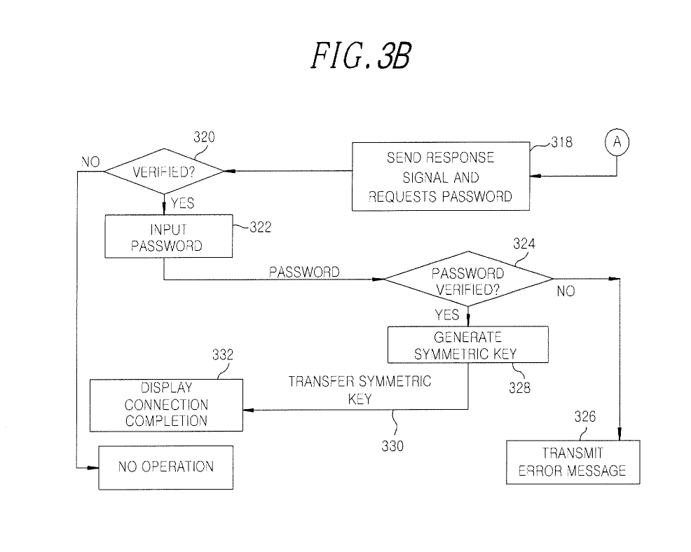

FIGS. 3A and 3B are a control flow diagram illustrating a process of performing a physical connection and password verification between the external apparatus 250 and the audio-security storage apparatus 100 in accordance with an embodiment of the present invention.

In operation 300, the audio-security storage apparatus 100 is connected to the external apparatus 250 by connecting the audio connector 120 of the audio-security storage apparatus to the audio jack of the external apparatus 250. When the connection between the audio-security storage apparatus 100 and the external apparatus 250 is completed and a voltage provided from the external apparatus 250 is supplied to the audio-security storage apparatus 100, the lamp 110 is lighted. In this connection, the lamp driving unit 216 checks whether or not the power supply unit 204 is driven, and makes the lamp 110 flicker.

In operation 302, the external apparatus 250 detects the physical connection with the security storage apparatus. There may be several ways to detect the physical connection between the audio-security storage apparatus 100 and the external apparatus 250. For example, in a case of a PC, the physical connection may be detected by a message such as WM_DEVICECHANGE or the like. In a case of an Android-based smart phone, the physical connection may be detected by a message such as ACTION_HEADSET_PLUG or the like. In operation 304, in order to check whether the connected apparatus is the audio-security storage apparatus 100, the external apparatus 250 transmits an identification message to the audio-security storage apparatus after converting an identification message into an audio (analog) signal.

Then, the audio-security storage apparatus 100 converts the received audio (analog) signal into a digital signal through the signal conversion unit 206 and transfers the converted digital signal to the signal identification unit 208. The signal identification unit 208 checks whether or not the converted digital signal is a related signal to the audio-security storage apparatus 100 through the function list stored in the certificate management unit 210. When the converted digital signal is the related signal to the audio-security storage apparatus 100, the signal identification unit 208 provides an acknowledgment signal to the control unit 212, and otherwise, the signal identification unit 208 regards the converted digital signal as an ordinary audio signal and does not perform any operation.

Thereafter, in operation 306, upon receiving the acknowledgment signal from the signal identification unit 208, the control unit 212 checks whether or not a password of the audio-security storage apparatus 100 has been registered in the certificate management unit 210.

If it is checked that the password has not been registered, the control process goes to operation 310; however, if it is checked that the password has been registered, the control process advances to operation 318.

The control unit 212 then requests the external apparatus 250 to register a password of the audio-security storage apparatus 100 in operation 308 and outputs a screen or a message for guiding a registration of a password to the external apparatus 250 to prompt the user to enter the password in operation 310. In other words, when a password of the audio-security storage apparatus 100 has not been registered, a message for requesting the external apparatus 250 to provide the password is displayed to the user.

In operation 312, when the user inputs the password, the password is transferred to the audio-security storage apparatus 100.

In operation 314, the control unit 212 verifies validity of the password received from the external apparatus 250. The verification of the validity of the password may be made by using a length, number, a character combination, and the like of the password.

When the verification of the password is successful, the control unit 212 registers the password in the certificate management unit 210 in operation 316.

Meanwhile, in operation 318, the control unit 212 sends a response signal indicating the successful identification of the audio-security storage apparatus 100 and a request signal for requiring the password of the audio-security storage apparatus 100 to the external apparatus 250.

In operation 320, the external apparatus 250 verifies the response signal. As a verification result, when the response signal is from the audio-security storage apparatus 100, the external apparatus 250 requests the user to input the password in operation 322. The password provided by the user will then provided to the audio-security storage apparatus 100. If, however, the response signal is not associated with the secure storage apparatus 100, the external apparatus 250 do not performs any operation.

Meanwhile, in operation 324, upon receiving the password, the control unit 212 of the audio-security storage apparatus 100 verifies whether or not the password is identical to a password stored in the certificate management unit 210. If the passwords are not identical with each other, the control unit 212 may request the password up to three times. When the verification of the password fails still up to three times, the control unit 212 transmits an error message to the external apparatus 250 in operation 326.

However, when the password verification is successful, the control process goes to operation 326 in which the audio-security storage apparatus 100 generates a symmetric key for the purpose of data communication with the external apparatus 250 and temporarily stores the symmetric key. In operation, the audio-security storage apparatus 100 transmits the verification result and the symmetric key to the external apparatus 250.

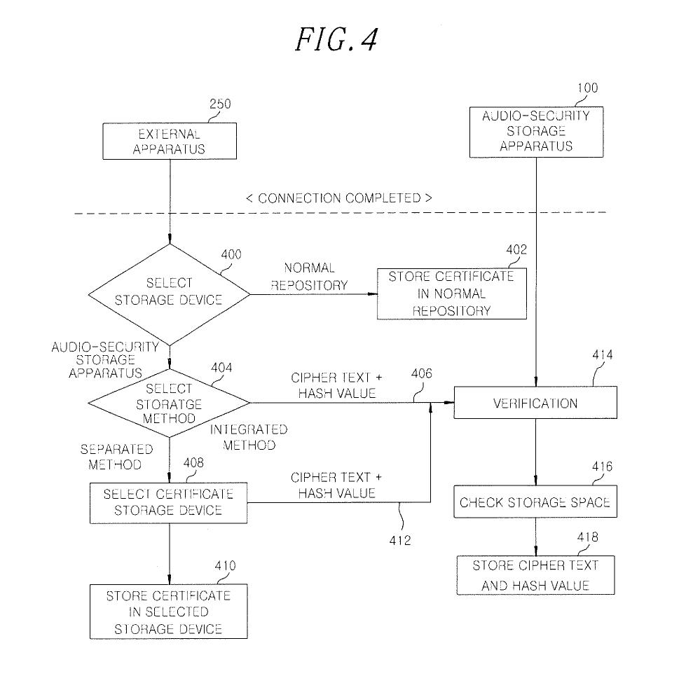

In operation 332, upon receiving the password verification result and the symmetric key, the external apparatus 250 temporarily stores the symmetric key and displays a message indicating the success of the physical connection with the audio-security storage apparatus 100 for user recognition. In this case, the message may be displayed by different ways for each external apparatus. For example, in a case where the external apparatus 250 is a PC, the message may be displayed in a manner of a pop-up window, and in a case where the external apparatus 250 is a communication terminal such as a smart phone, the message may be displayed by differentiating color of icons on a state line. For example, in a case of “success”, the icon is expressed in blue, and in a case of “fail”, the icon is expressed in red. FIG. 4 is a control flow diagram illustrating a process of storing a certificate in the audio-security storage apparatus in accordance with an embodiment of the present invention.

This process of storing a certificate in the audio-security storage apparatus will follow the process described with reference to FIGS. 3A and 3B.

When the process illustrated in FIGS. 3A and 3B has been normally completed, in operation 400, the external apparatus 250 requests the user to select a device for storing a certificate. The device of storing the certificate may be normal repositories such as a PC, an external memory, a security token, a smart phone, and the like. When the user selects a repository other than the audio-security storage apparatus 100, the certificate will be stored in the repository according to a conventional method in operation 402. Meanwhile, when the user selects the audio-security storage apparatus 100, the external apparatus 250 requests the user to select a storage method of the certificate in operation 404.

The storage method may be categorized into an integrated storage method and a separated storage method. The integrated storage method refers to a method of storing both of the certificate and the digital signature key in the audio-security storage apparatus 100. Meanwhile, the separated storage method refers to a method of storing entity information of the certificate and the digital signature key, which means that only the digital signature key is separately stored in the audio-security storage apparatus 100. When the certificate and the digital signature key are separated, safety of the certificate may be enhanced even when the certificate is lost.

When the integrated storage method is selected, the control process proceeds to operation 406; however, when the separated storage method is selected, the process advances to operation 408.

In operation 406, the external apparatus 250 encrypts the certificate and the digital signature key using the symmetric key to produce a cipher text, and transmits the cipher text along with a hash value for the certificate and the digital signature key to the audio-security storage apparatus 100.

Meanwhile, in operation 408, the user selects a device for separately storing the certificate. Upon selecting the certificate storage device, the certificate is stored in the selected storage device in operation 410, and at the same time, a cipher text obtained by encrypting the entity information of the certificate and the digital signature key by using the symmetric key, and a hash value for the entity information and the digital signature key are provided to the audio-security storage apparatus 100. The device of separately storing the certificate may be a PC, an external memory, a security token, and the like.

In operation 414, the audio-security storage apparatus 100 decrypts the cipher text received from the external apparatus 250 through the use of the symmetric key, and checks the hash value to perform verification of the cipher text.

When the verification is normally achieved, the audio-security storage apparatus 100 checks a usable storage space in the certificate management unit 210 in operation 416.

When there is a usable storage space, the audio-security storage apparatus 100 stores the cipher text and hash value in the form of Key/Value in the certificate management unit 210 in operation 418.

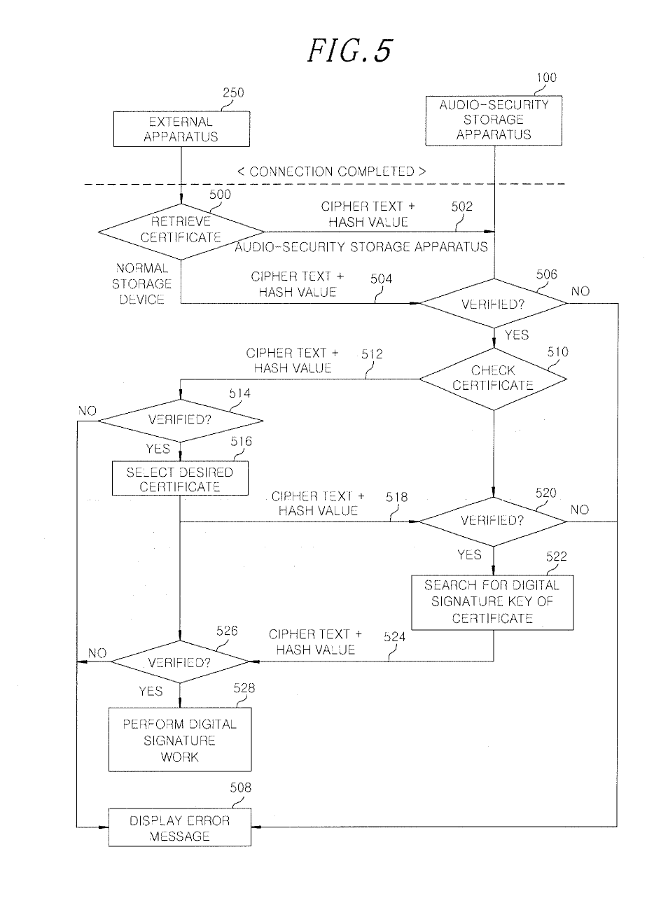

FIG. 5 is a control flow diagram illustrating a process of using the certificate stored in the audio-security storage apparatus 100 in accordance with an embodiment of the present invention.

This process of using the certificate stored in the audio-security storage apparatus will follow the process described with reference to FIGS. 3A and 3B.

In operation 500, the external apparatus 250 requests the user to provide what a device the user desires to retrieve the certificate. The device for retrieving the certificate may be a normal repository such as a PC, an external memory, and the like, or the audio-security storage apparatus 100. In a case of the normal repository, in operation 502, the external apparatus 250 retrieves entity information of the certificate stored in the selected device and encrypts the retrieved entity information using the digital signature key to produce a cipher text and a hash value for the entity information and the digital signature key. The cipher text and the hash value are then transmitted to the audio-security storage apparatus 100.

Meanwhile, in a case of the audio-security storage apparatus 100, in operation 504, the external apparatus 250 produces a signal requesting entity information of certificate(s) stored in the audio-security storage apparatus 100 and encrypts the request signal using the digital signature key to create a cipher text and a hash value for the request signal and the digital signature key. The cipher text and the hash value are then transmitted to the audio-security storage apparatus 100.

Next, in operation 506, the audio-security storage apparatus 100 decrypts and verifies the cipher text and hash value.

When the verification fails, the control process advances to operation 508 in which the audio-security storage apparatus 100 transmits an error message to the external apparatus 250. However, when the verification is successful, the control process goes to operation 510 in which the audio-security storage apparatus 100 confirms the certificate. The confirmation of the certificate differs from which the certificate was retrieved.

In a case of the normal storage device, the audio-security storage apparatus 100 checks whether or not the entity information transferred from the external apparatus 250 is stored in the certificate management unit 210, and encrypts and transmits only the checked entity information to the external apparatus 250. For example, it is assumed that entity information of five certificates from the external apparatus 250 is compared with entity information of certificates stored in the certificate management unit 210. If only entity information of three certificates is identical, the entity information of three certificates is encrypted and transmitted to the external apparatus 250. This is because a digital signature key of the certificate which is not identical may not have been stored in the audio-security storage apparatus 100. In this manner, only the certificates corresponding to the digital signature keys are provided to the user.

In a case of the audio-security storage apparatus 100, only entity information of every certificate stored in the certificate management unit 210 is encrypted and transmitted to the external apparatus 250 in operation 512.

Thereafter, in operation 514, external apparatus 250 decrypts the encrypted cipher text and hash value transmitted from the security apparatus 100 and verifies the same.

When the verification fails, the external apparatus 250 displays an error message in operation 508. However, when the verification is successful, in operation 516, the external apparatus 250 outputs a list of the entity information of the certificates such that the user selects any desired certificate from the list.

In operation 518, the external apparatus 250 encrypts the selected certificate and transmits a cipher text and hash value to the audio-security storage apparatus 100.

Subsequently, in operation 520, the audio-security storage apparatus 100 decrypts and verifies the cipher text transmitted from the external apparatus 250.

When the verification fails, the audio-security storage apparatus 100 displays an error message on the external apparatus 250 as in operation 508. However, when the verification is successful, in operation 522, the audio-security storage apparatus 100 searches the certificate management unit 210 for a certificate corresponding to the entity information transmitted from the external apparatus 250.

Thereafter, in operation 524, the audio-security storage apparatus 100 encrypts the certificate and/or the digital signature key thereof and transmits a cipher text and a hash value for the certificate and/or the digital signature key to the external apparatus 250.

In operation 526, the external apparatus 250 decrypts and verifies the cipher text and hash value from the audio-security storage apparatus 100. When the verification fails, the external apparatus 250 displays an error message as in operation 508. However, when the verification is successful, in operation 528, the external apparatus 250 performs a digital signature work. The description of the digital signature work is a well-known in the art and therefore will be omitted.

In accordance with the embodiments, the external device can use the same certificate as stored in the secure storage apparatus although the certificate is not duplicated or transferred to the external apparatus. Accordingly, inconvenience of duplicating a certificate to a smart phone or any other external apparatus whenever the certificate is needed can be avoided, which leads to enhance user convenience and prevent a leakage of a certificate that may be caused due to unnecessary duplication of the certificate.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A audio-security storage apparatus comprising:
an audio connector adapted to connect to an audio jack equipped in an external apparatus; and
a audio-security storage module configured to transmit information on certificates to the external apparatus or receive information on certificates from the external apparatus for the storage thereof.

2. The audio-security storage apparatus of claim 1, further comprising a gender configured to perform an interface between the external apparatus and the security storage apparatus.

3. The audio-security storage apparatus of claim 1, wherein the audio-security storage module comprises:
an input/output interface configured to receive or transmit signals through the audio connector;
a signal conversion unit configured to convert analog signals received from the external apparatus through the input/output interface into digital signals or convert digital signals generated in the audio-security storage apparatus into analog signals;
a certificate management unit storing a list of functions corresponding to the digital signals and the information of the certificates;
a signal identification unit configured to identify only digital signals associated with certification, among the digital signals converted through the signal conversion unit, based on the list; and
a control unit configured to perform a function corresponding to the identified digital signal.

4. The audio-security storage apparatus of claim 3, wherein the control unit is configured to perform a function of generating a response signal depending on a request from the external apparatus, a function of generating a symmetric key for encryption of the information on the certificates, a password verification function of verifying a password stored in the certificate management unit and a password received from the external apparatus, and a function of checking integrity of data transmitted between the external apparatus and the security storage device.

5. The audio-security storage apparatus of claim 3, wherein the audio-security storage module further comprises:
an encryption/decryption unit configured to encrypt or decrypt signals communicated between the external apparatus and the security storage device.

6. The audio-security storage apparatus of claim 3, wherein the audio-security storage module further comprises:
a power supply unit configured to supply a power to the audio-security storage apparatus using the signal received through the input/output interface.

7. The audio-security storage apparatus of claim 3, wherein the control unit is configured to store a certificate and a digital signature key thereof in the certificate management unit, or store entity information of a certificate and a digital signature key thereof in the certificate management unit.

8. The audio-security storage apparatus of claim 1, wherein the audio-security storage module further comprises:
a lamp driving unit configured to flicker a lamp depending on whether or not the power is supplied to the audio-security storage apparatus and provide a function of turning on or off the power to the security storage apparatus.

9. The audio-security storage apparatus of claim 1, wherein the audio connector comprises a 4-pole audio connector, the 4-pole audio plug having a stereo 2-pole for an input channel, a ground 1-pole for a terminal to supply the power, and a microphone 1-pole for an output channel.

10. A method for managing certificates, the method comprising:
detecting a connection of a audio-security storage apparatus to an audio jack of an external apparatus;
receiving an identification message from the external apparatus;
checking whether or not a password has been registered when the identification message is included in a predetermined function list;
transmitting an acknowledgement signal for the identification message and a password request signal to the external apparatus;
receiving a response for the password request signal from the external apparatus;
comparing the response and the password to verify the password;
generating a symmetric key for data communication with the external apparatus when the verification is completed; and
displaying a connection result when the connection of the external apparatus and the security storage device is completed.

11. The method of claim 10, further comprising:
providing a message to register the password to the external apparatus when the password has not been registered;
receiving the password from the external apparatus; and
transmitting a response signal to the receipt of the password to the external apparatus.

12. The method of claim 10, further comprising:
receiving a cipher text which is obtained by encrypting a certificate and a digital signature key using the symmetrical key and a hash value for the certificate and the digital signature key from the external apparatus for the storage of the same in a certificate management unit.

13. The method of claim 10, further comprising:
receiving a cipher text which is obtained by encrypting entity information of a certificate and a digital signature key thereof using the symmetrical key and a hash value for the entity information of the certificate and the digital signature key from the external apparatus for the storage of the same in a certificate management unit.

14. The method of claim 12, wherein the cipher text and the hash value are checked to perform verification thereof before being stored in the certificate management unit.

15. The method of claim 12, further comprising:
receiving signals requesting entity information of certificates from the external apparatus;
extracting entity information of certificates stored in the certificate management unit according to the received signals;
selecting any one of the entity information of the certificates;
searching the certificate management unit for a certificate corresponding to the selected entity information; and
encrypting the searched certificate and a digital signature key of the searched certificate to transmit the same to the external apparatus.

16. The method of claim 12, further comprising:
receiving entity information of certificates stored in a storage device from the external apparatus;
extracting the entity information of certificates by comparing the received entity information and entity information stored in the certificate management unit;
transmitting the extracted certificate information to the external apparatus, wherein the external apparatus extracts a certificate corresponding to the selected entity information from the storage device when selected any one of the transmitted entity information of certificates;
searching the certificate management unit for a certificate identical to the selected entity information; and
encrypting a digital signature key of the searched certificate to transmit the same to the external apparatus.
